(19) United States
(12) Patent Application Publication
(10) Pub. No.: US 2006/0037199 A1
(43) Pub. Date: Feb. 23, 2006

(54) Fastener ripper

(76) Inventor: Alexander G. Alpert, Southborough, MA (US)

Correspondence Address: FISH & RICHARDSON P.C., P.O. BOX 1022, MINNEAPOLIS, MN, 55440-1022, US

(21) Appl. No.: 10/921,816

(22) Filed: Aug. 20, 2004

(51) Int. Cl. B26B 3/00

(52) U.S. Cl. 30/169

(57) ABSTRACT

A fastener ripper includes a handle, a joint assembly, and an elongate blade replaceably coupled to the handle by the joint assembly. The blade is configured to engage and rip a fastener. The joint assembly includes a first mating portion, a second mating portion, and a member securing the mating portions. The first mating portion includes a raised portion of the blade and the second mating portion includes a countersunk portion in the handle configured to engage the raised portion. Alternatively, the first mating portion includes a step in the elongate blade and the second mating portion includes a step in the handle configured to engage the step in the elongate blade. Alternatively, the first mating portion is substantially flat, the second mating portion is substantially flat, and the member securing the mating portions includes a base plate, dowels and screws.

This invention relates to a fastener ripper and, more particularly, to a device for removing fasteners from roofing.

### BACKGROUND

Fastener rippers for removing fasteners from roofing are known that include a handle connected to a thin, elongate blade that can be slid under the roofing material. The blade has a head that engages and rips the fastener holding the roofing material to the roof. It is also known to weld portions of a blade that break-off when ripping a fastener back onto the blade to allow the blade to be reused.

### SUMMARY

According to the invention, a fastener ripper includes a handle, a joint assembly, and an elongate blade replaceably coupled to the handle by the joint assembly. The blade is configured to engage and rip a fastener.

Embodiments of this aspect of the invention may include one or more of the following features.

The joint assembly includes a screw. The joint assembly includes a first mating portion, a second mating portion, and a member securing the first mating portion to the second mating portion. The first mating portion includes a raised portion of the blade and the second mating portion includes a countersunk portion in the handle configured to engage the raised portion. Alternatively, the first mating portion includes, e.g., one or two steps in the elongate blade defining faces arranged substantially perpendicular to a long axis of the elongate blade. The second mating portion includes, e.g., one or two steps in the handle defining faces arranged substantially perpendicular to a long axis of the handle. The steps in the handle are configured to engage the steps in the elongate blade.

In an illustrated embodiment, the first mating portion is substantially flat, the second mating portion is substantially flat, and the member securing the first mating portion to the second mating portion includes a base plate. The first mating portion is positioned between the second mating portion and the base plate. The first mating portion, the second mating portion, and the base plate define aligned holes. The member further includes dowels received in the aligned holes, and screws.

The elongate blade is substantially flat, and has a thickness in the range of about 0.06 to 0.1 inches, preferably about 0.08 inches. The elongate blade is typically more than about 12 inches, 18 inches, 24 inches, or 30 inches long, though shorter or longer blades can also be useful.

The handle includes a strike surface arranged substantially perpendicular to a long axis of the handle, and the blade defines a fastener ripper slot.

According to another aspect of the invention, a blade includes a head configured to engage and rip a fastener, a handle attachment site configured to be replaceably attached to a handle, and an elongate body extending between the handle and the handle attachment site.

According to another aspect of the invention, a fastener ripper kit includes a handle and a plurality of elongate blades configured to be interchangeably coupled to the handle. The blades are configured to engage and rip a fastener.

According to another aspect of the invention, a method of exchanging blades of a fastener ripper includes detaching a first elongate blade from a handle and attaching a second elongate blade to the handle. The second blade is configured to engage and rip a fastener.

Advantages of the invention may include a joint assembly that permits easy replacement and exchange of the relatively inexpensive blade portion of a fastener ripper when the blade is damaged due to high loads encountered when ripping a fastener. The joint assembly resists shear forces encountered during fastener ripping. With the fastener ripper kit of the invention, the user need only purchase a single handle for use with a variety of sized blades applicable to different roofing materials. Moreover, replacement can be performed on site without the need for welding equipment.

The details of one or more embodiments of these invention are set forth in the accompanying drawings and the description below. Other features, objects, and advantages of the invention will be apparent from the description and drawings, and from the claims.

### DESCRIPTION OF DRAWINGS

FIG. 1 illustrates a slate ripper according to the present invention;

FIG. 2A is an exploded view of the slate ripper of FIG. 1;

FIG. 2B is a view of the slate ripper taken along lines 2B-2B of FIG. 2A;

FIG. 2C is a cross-sectional view of the slate ripper taken along lines 2C-2C of FIG. 2B;

FIG. 3 is an exploded view of an alternative embodiment of a slate ripper according to the present invention;

FIG. 4 is an exploded view of an additional alternative embodiment of a slate ripper according to the present invention;

FIG. 5 is an exploded view of an additional alternative embodiment of a slate ripper according to the present invention;

FIG. 6 illustrates a fastener ripper kit including the slate ripper of FIG. 5; and

FIG. 7 illustrates a strike pin on a strike face of a slate ripper.

### DETAILED DESCRIPTION

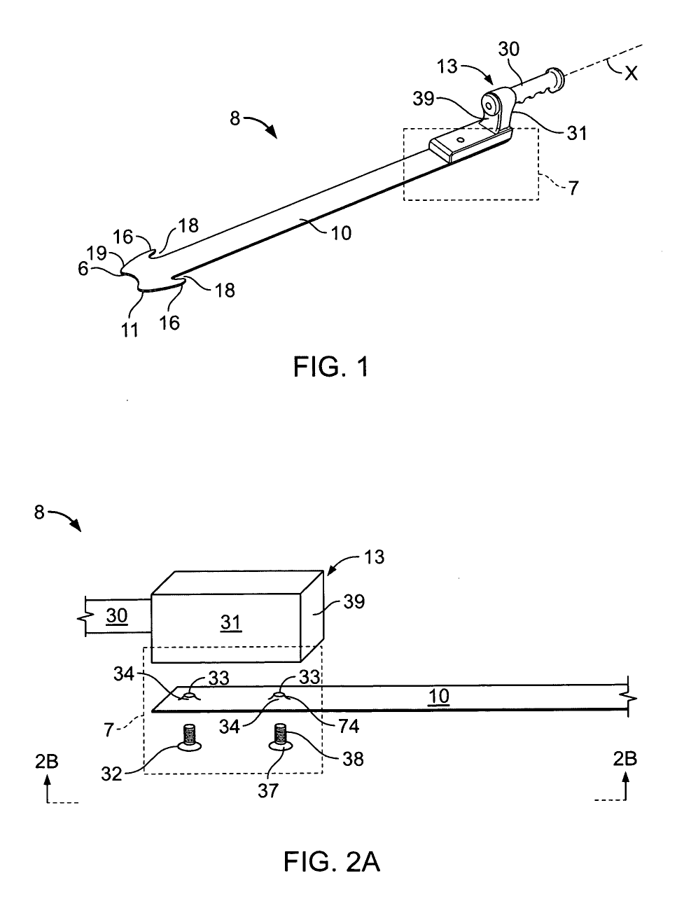

Referring to FIG. 1, a slate ripper 8 has an elongate blade 10 and a handle 13 extending along a long axis, X, of slate ripper 8. Blade 10 is replaceably connected to handle 13 by a joint assembly 7. Blade 10 includes a head 19 with tabs 16 that define a pair of slots 18, and a concave portion 6. Handle 13 has a grip 30 and a handle body 31 that includes a strike face 39 arranged substantially perpendicular to axis, X, e.g., about 90 degrees to axis, X. As shown in FIG. 7, the strike face 39 can be formed, for example, by a strike pin 39a made of S1 steel and heat-treated to withstand hard usage, thus providing a strong, wear resistant material at the point of contact.

Blade 10 can be dimensioned for operation with a variety of roofing materials. For example, asphalt roofing shingles are commonly 12 inches tall, whereas slate roofing shingles are commonly between 20 and 30 inches tall. Blade 10 has a length preferably, longer than about 12 inches, longer than about 18 inches, longer than about 24 inches, or longer than about 30 inches, though shorter or longer blades can be used according to the application. Blade 10 has a width in the range of about one to three inches, preferably about 1.5 inches, and a thickness in the range of about 0.06 to 0.1 inches, preferably about 0.08 inches. Blade 10 is substantially flat along its length to facilitate insertion beneath a roofing shingle. Blade 10 is made, e.g., from tool steel, 17-4 precipitation hardened stainless steel, or other suitable materials.

During operation, the user holds grip 30, slides head 19 and a suitable length of blade 10 under a roofing material, e.g., slate roofing, and positions head 19 such that a fastener (e.g., a nail) that attaches the roofing material to a roof is located within one of slots 18. The user rips the fastener by, e.g., manually pulling grip 30 or striking face 39 with a hammer. This results in withdrawal of the body of the fastener from the retaining surface, withdrawal of the head of the fastener from the roofing material, and/or shearing of the fastener. The concave portion 6 can be used to cut or push fasteners in an upward motion.

During use, due to high loads placed on tabs 16 when ripping the fastener, a tab 16 may break off head 19 or the entirety of head 19 may break off. The attachment of blade 10 to handle 13 by joint assembly 7 facilitates replacement by the user of the damaged blade with an intact blade.

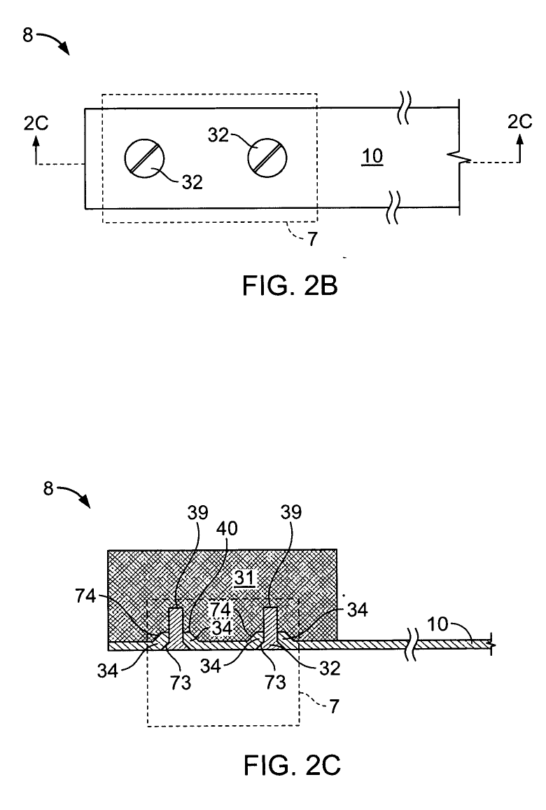

Referring to FIGS. 2A-2C, joint assembly 7 includes joining members, e.g., two screws 32, each having a head 37 and a threaded body 38. Blade 10 defines two through holes 33 and handle body 31 defines two threaded bore holes 39 for receiving screws 32 to replaceably connect blade 10 to handle 13. While two screws 32 are shown, fastener ripper 8 can include more screws and the corresponding number of holes in blade 10 and handle 13. Blade holes 33 are dimensioned to pass screw body 38 but not screw head 37. Holes 33 are circumferentially surrounded by a mating portion, e.g., a raised lip 34 that has a raised face 74 and a countersunk face 73. Countersunk face 73 receives screw head 37. Handle body 31 has a mating portion, e.g., countersunk ends 40 of bore holes 39 which receive raised face 74 of lip 34 such that lip 34 penetrates into handle body 31 when blade 10 is fixed to handle 13 with screws 32, as illustrated in FIG. 2C.

The interface between blade lip 34 and countersunk ends 40 of handle bores 39 withstands the large shear forces generated between handle 13 and blade 10 when ripping a fastener to limit the possibility of blade 10 being ripped from handle 13 during use. The design of the interface reduces any shear force exerted on the screws and puts most if not all of the shear force on the blade and handle.

Other embodiments are within the scope of the claims.

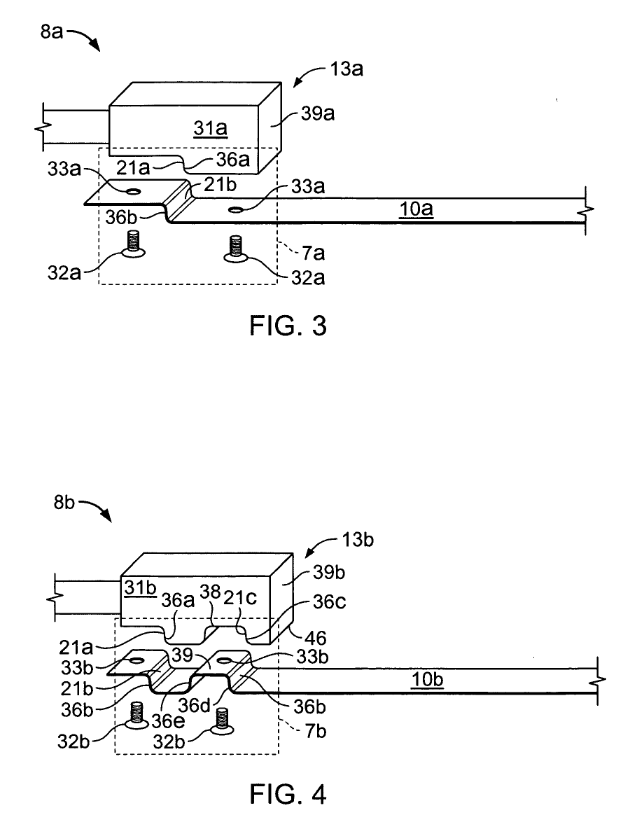

For example, referring to FIG. 3, a slate ripper 8a includes a blade 10a, a handle 13a with a handle body 31a and strike surface 39a, and a joint assembly 7a releasably coupling blade 10a to handle 13a. Joint assembly 7a includes screws 32a received in holes 33a in blade 10a and bore holes (not shown) in handle 13a, as described above, and mating faces 21a, 21b. Mating face 21a is formed by a step 36a in handle body 31a such that face 21a is arranged substantially perpendicular, e.g., about 80 degrees, to the long axis, X (FIG. 1), of slate ripper 8a. Mating face 21b is formed by a step 36b in blade 10a such that face 21b is also arranged substantially perpendicular, e.g., about 80 degrees, to the long axis, X. When slate ripper 8a is assembled, faces 21a, 21b are in contact to resist shear forces that would tend to rip blade 10a from handle 13a.

Referring to FIG. 4, a slate ripper 8b includes a blade 10b, a handle 13b with a handle body 31b and strike surface 39b, and a joint assembly 7b releasably coupling blade 10b to handle 13b. Joint assembly 7b includes screws 32b received in holes 33b in blade 10b and bore holes (not shown) in handle 13b, and mating faces 21a, 21b, as described above. In addition to mating faces 21a, 21b, handle body 31b defines a notch 38 with a step 36c forming a mating face 21c, and blade 10b includes a bent region 89 formed by steps 36d and 36e. Step 36d forms a mating face 21d. Mating faces 21c, 21d are arranged substantially perpendicular, e.g., about 80 degrees, to the long axis, X (FIG. 1), of slate ripper 8b. When slate ripper 8b is assembled, faces 21a, 21b and 21c, 21d are in contact to resist shear forces that would tend to rip blade 10b from handle 13b.

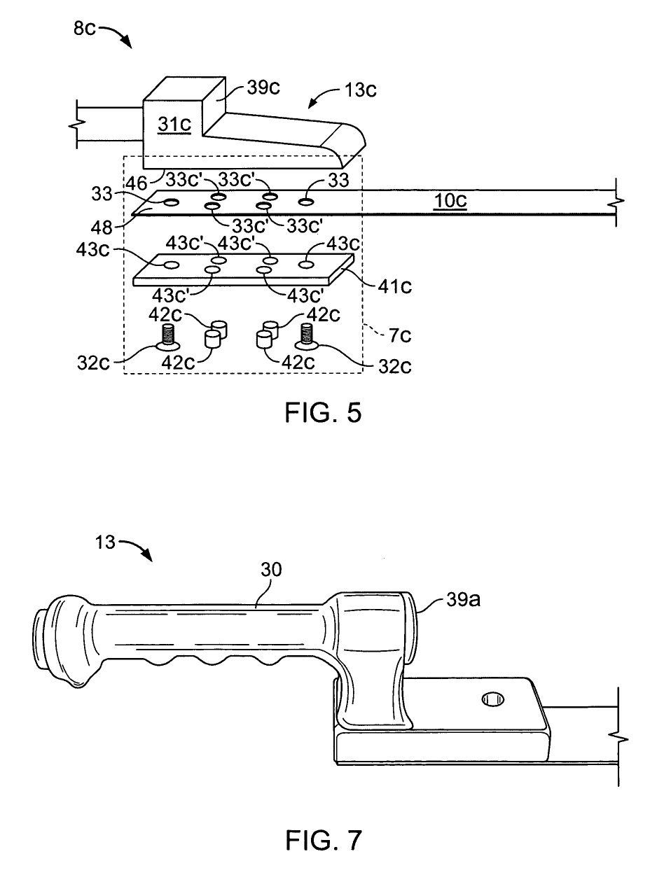

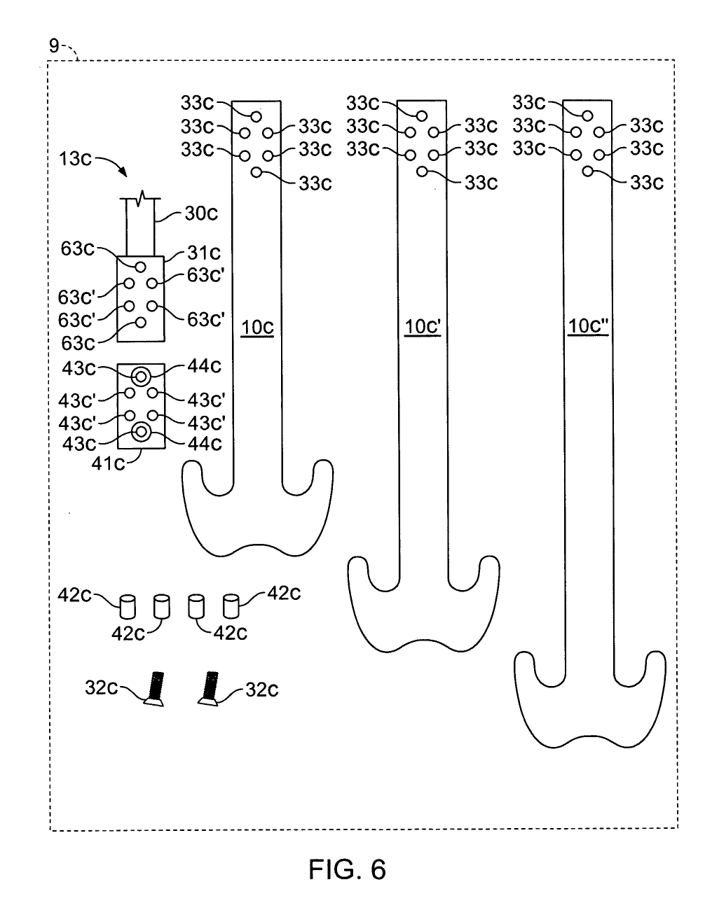

Referring to FIG. 5, a slate ripper 8c includes a blade 10c, a handle 13c with a handle body 31c and strike surface 39c, and a joint assembly 7c releasably coupling blade 10c to handle 13c. Joint assembly 7c includes screws 32c, dowels 42c, for example four dowels, a base plate 41c, and flat mating surfaces 46, 48 of handle body 31c and blade 10c, respectively. Screws 32c are received in holes 33c in blade 10c, threaded bore holes 63c′ (FIG. 6) in handle 13c, and holes 43c in plate 41c. Dowels 42c are received in holes 33c′ in blade 10c, holes 63c′ (FIG. 6) in handle 13c, and holes 43c′ in plate 41c. Dowels 42c are compression fitted into holes 43c′.

Referring to FIG. 6, a fastener ripper kit 9 includes, e.g., handle 13c, base plate 41c fasteners 32c, and dowels 42c illustrated in FIG. 5 along with a plurality of interchangeable blades 10c, 10c′, 10c″. Blades 10c, 10c′, 10c″ have different lengths. Alternatively, kit 9 can include a plurality of interchangeable blades having the same length so that when a first blade is damaged during use, a second, undamaged blade with similar characteristics can be substituted. Fastener ripper kits can likewise be formed using the embodiments of FIGS. 2-4.

In practice, a user repairs or adapts the slate ripper by detaching first blade 10c′ from handle 13c. The user might decide to do this when, e.g., first blade 10c′ is damaged or the user is working with roofing materials that are incompatible with the dimensions of first blade 10c′. For example, a user who switches from an asphalt roof to a slate roof can replace a shorter first blade 10c′ with a longer second blade 10c″. Detachment of first blade 10c′ from handle 13c is performed by removing fasteners 32c from handle body 31c and then removing base plate 41c with dowels 42c. Blade 10c′ is then separated from handle 13c, and a new blade 10c″ is selected. Blade 10c″ is sandwiched between handle 13c and base plate 41c with dowels 42c passing through blade 10c″ into handle 13c. The blade, handle and base plate are then secured together with screws 32c.

A number of embodiments of the invention have been described. Nevertheless, it will be understood that various modifications may be made without departing from the spirit and scope of the invention. For example, holes 32 can be countersunk in the blade of any of the slate rippers illustrated herein. The number, size, and geometry of step(s) 36 can be varied or combined with any number of fasteners and/or dowel members as described herein. Accordingly, other embodiments are within the scope of the following claims.

What is claimed is:

1. A fastener ripper comprising:
a handle,
a joint assembly, and
an elongate blade replaceably coupled to said handle by said joint assembly, said blade configured to engage and rip a fastener.

2. The fastener ripper of claim 1 wherein said joint assembly comprises a screw.

3. The fastener ripper of claim 1 wherein said joint assembly comprises:
a first mating portion,
a second mating portion, and
a member securing the first mating portion to the second mating portion.

4. The fastener ripper of claim 3 wherein said first mating portion comprises a raised portion of said blade.

5. The fastener ripper of claim 3 wherein said second mating portion comprises a countersunk portion in said handle.

6. The fastener ripper of claim 3 wherein said first mating portion comprises a raised portion of said blade and said second mating portion comprises a countersunk portion in said handle configured to engage said raised portion.

7. The fastener ripper of claim 3 wherein said first mating portion comprises a step in said elongate blade defining a face arranged substantially perpendicular to a long axis of said elongate blade.

8. The fastener ripper of claim 7 wherein said first mating portion further comprises a second step in said elongate blade defining a second face arranged substantially perpendicular to a long axis of said elongate blade.

9. The fastener ripper of claim 3 wherein said second mating portion comprises a step in said handle defining a face arranged substantially perpendicular to a long axis of said handle.

10. The fastener ripper of claim 9 wherein said second mating portion further comprises a second step in said handle defining a second face arranged substantially perpendicular to a long axis of said handle.

11. The fastener ripper of claim 3 wherein said first mating portion comprises a step in said elongate blade defining a face arranged substantially perpendicular to a long axis of said elongate blade, and said second mating portion comprises a step in said handle defining a face arranged substantially perpendicular to a long axis of said handle, said step in said handle configured to engage said step in said elongate blade.

12. The fastener ripper of claim 3 wherein said first mating portion is substantially flat and said second mating portion is substantially flat, said member comprising a base plate, said first mating portion being positioned between said second mating portion and said base plate.

13. The fastener ripper of claim 12 wherein said first mating portion, said second mating portion, and said base plate define aligned holes.

14. The fastener ripper of claim 13 wherein said member further comprises dowels received in said aligned holes.

15. The fastener ripper of claim 3 wherein said member comprises a screw.

16. The fastener ripper of claim 15 wherein said member comprises two screws.

17. The fastener ripper of claim 1 wherein said elongate blade is substantially flat.

18. The fastener ripper of claim 17 wherein said elongate blade has a thickness in the range of about 0.06 to 0.1 inches.

19. The fastener ripper of claim 18 wherein said elongate blade has a thickness of about 0.08 inches.

20. The fastener ripper of claim 1 wherein said handle comprises a strike surface arranged substantially perpendicular to a long axis of said handle.

21. The fastener ripper of claim 20 wherein said strike surface comprises a strike pin.

22. The fastener ripper of claim 1 wherein said elongate blade defines a fastener ripper slot.

23. A blade comprising:
a head configured to engage and rip a fastener,
a handle attachment site configured to be replaceably attached to a handle, and
an elongate body extending between said handle and said handle attachment site.

24. The blade of claim 23 wherein said handle attachment site comprises a raised portion of said blade.

25. The blade of claim 24 wherein said blade further comprises a through hole and said raised portion is circumferentially arranged about said through hole.

26. The blade of claim 23 wherein said handle attachment site comprises a step in said blade defining a face arranged substantially perpendicular to a long axis of said blade.

27. The blade of claim 26 wherein said handle attachment site further comprises a second step in said blade defining a second face arranged substantially perpendicular to a long axis of said blade.

28. The blade of claim 23 wherein said handle attachment site comprises a through hole defined in said blade.

29. The blade of claim 28 wherein said handle attachment site comprises two through holes defined in said blade.

30. The blade of claim 26 wherein said elongate blade is substantially flat.

31. The blade of claim 23 wherein said elongate blade has a thickness in the range of about 0.06 to 0.1 inches.

32. The blade of claim 31 wherein said elongate blade has a thickness of about 0.08 inches.

33. The blade of claim 23 wherein said head defines a fastener ripper slot.

34. A fastener ripper kit, comprising:
a handle, and
a plurality of elongate blades configured to be interchangeably coupled to said handle, said blades configured to engage and rip a fastener.

35. A method of exchanging blades of a fastener ripper, comprising:
detaching a first elongate blade from a handle; and
attaching a second elongate blade to said handle, said second blade configured to engage and rip a fastener.

36. A fastener ripper comprising:
a handle,
an elongate blade configured to engage and rip a fastener, and
means for replaceably coupling said elongate blade to said handle.
